(19) United States
(12) Patent Application Publication
(10) Pub. No.: US 2022/0033543 A1
(43) Pub. Date: Feb. 3, 2022

(54) POLYOLEFIN COMPOSITION FOR CARPET BACKING

(71) Applicant: BASELL POLIOLEFINE ITALIA S.R.L., MILANO (IT)

(72) Inventors: GIANLUCA MUSACCHI, FERRARA (IT); ROBERTA MARCHINI, FERRARA (IT); STEFANO SPATARO, FERRARA (IT); STEFANO PASQUALI, FERRARA (IT)

(73) Assignee: BASELL POLIOLEFINE ITALIA S.R.L., MILANO (IT)

(21) Appl. No.: 17/312,570

(22) PCT Filed: Dec. 17, 2019
(86) PCT No.: PCT/EP2019/085694

§ 371 Date: Jun. 10, 2021

(30) Foreign Application Priority Data
Dec. 20, 2018 (EP) 18214541.7

(51) Int. Cl. C08F 110/08; C08K 3/26; D06N 7/00

(52) U.S. Cl. CPC C08F 110/08; C08K 3/26; C08K 2201/005; C08F 2800/20; C08K 2003/265; D06N 7/0076

(57) ABSTRACT

A filled polyolefin composition made from or containing butene-1 copolymers having high melt flow and an inorganic filler. The compositions are useful for carpet backing.

### FIELD OF THE INVENTION

In general, the present disclosure relates to the field of chemistry. More specifically, the present disclosure relates to polymer chemistry. In particular, the present disclosure relates to a polyolefin-based composition for carpet backing.

### BACKGROUND OF THE INVENTION

In some instances, the underside of carpets is made from or containing several layers having the function of securing the tufts and of giving the carpet additional strength and dimensional stability. In some instances, carpets have a double backing: a primary backing where the yarn is fixed, and a secondary backing which provides dimensional stability. The primary and secondary baking are glued by latex, emulsions of synthetic rubbers or hot melt adhesive (HMA) compositions.

In some instances, flowable compositions containing ex-reactor butene-1 copolymers having MFR in the range from 200 to 1,500 g/10 min glue the tuft to the primary carpet backing in tufted or needle-punched carpets.

In some instances, the carpet secondary backing is made from different materials, such as compositions made from or containing bitumen and inorganic filler. It is believed that these carpets have limited recyclability at the end of their service life due to difficult delamination of the bitumen-containing layer.

In some instances, butene-1 polymer compositions containing butene-1 polymers having melt flow rate values up to 150 g/10 min., a large amount of filler and hydrocarbon oils are used as backing materials of carpets to substitute bitumen-based compositions. However and in some instances, the presence of hydrocarbon oils compromises the elasticity of the backing layer and oil blooming alters the aesthetic appearance of the carpet.

### SUMMARY OF THE INVENTION

In a general embodiment, the present disclosure provides a filled polyolefin composition made from or containing:

(A) a copolymer of butene-1 with a comonomer selected from the group consisting of ethylene, propylene, C5-C10 alpha-olefins and mixtures thereof, having copolymerized comonomer content of 0.5-5.0 wt. % and Melt Flow Rate (MFR) values measured according to ISO 1133 (190° C., 2.16 kg) higher than or equal to 200 g/10 min and
(B) up to 80 wt. % of an inorganic filler,
wherein the amounts of (A) and (B) are referred to the total weight of (A)+(B).

In some embodiments, the present disclosure provides a method of manufacturing a carpet including a step of applying, to the underside of a primary carpet backing, a layer made from or containing the polyolefin composition.

In some embodiments, the present disclosure provides a carpet made from or containing a backing layer made from or containing the polyolefin composition.

### BRIEF DESCRIPTION OF THE DRAWINGS

The claimed subject matter may be understood by reference to the following description taken in conjunction with the accompanying figures in which:

FIG. 1 is a graph showing the viscoelastic properties (E′, E″ and Tan 6) of a butene-1 copolymer plotted as a function of temperature, measured by DMTA.

FIG. 2 is a graph showing the viscoelastic properties of the polyolefin composition of Example 1 plotted as a function of temperature, measured according to the DMTA Method.

FIG. 3 is a graph showing the viscoelastic properties of the polyolefin composition of Example 2 plotted as a function of temperature, measured according to the DMTA Method.

FIG. 4 is a graph showing the viscoelastic properties of the polyolefin composition of Example 3 plotted as a function of temperature, measured according to the DMTA Method.

### DETAILED DESCRIPTION OF THE INVENTION

As used herein, the term “room temperature” refers to a temperature of 25±2° C. measured at 50% of relative humidity.

In a general embodiment, the present disclosure provides a filled polyolefin composition made from or containing:

(A) a copolymer of butene-1 with a comonomer selected from the group consisting of ethylene, propylene, C5-C10 alpha-olefins and mixtures thereof, having copolymerized comonomer content of 0.5-5.0 wt. % and Melt Flow Rate (MFR) values measured according to ISO 1133 (190° C., 2.16 kg) higher than or equal to 200 g/10 min and
(B) up to 80 wt. % of an inorganic filler,
wherein the amounts of (A) and (B) are referred to the total weight of (A)+(B), the total weight of (A)+(B) amounting to 100%.

In some embodiments, the butene-1 copolymer component (A) has a MFR measured according to ISO 1133 (190° C., 2.16 kg) of from 200 to 3,000 g/10 min, alternatively from 400 to 2,700 g/10 min, alternatively of from 600 to 2,500 g/10 min, alternatively of from 800 to 2,000 g/10 min.

In some embodiments, the butene-1 copolymer component (A) has a MFR measured according to ISO 1133 (190° C., 2.16 kg) of from 1,000 to 1,600 g/10 min.

In some embodiments, the comonomer is selected from the group consisting of ethylene, propylene, C5-C10 alpha-olefins and mixtures thereof.

In some embodiments, the comonomer is selected from the group consisting of ethylene, propylene, hexene-1, octene-1 and mixture thereof.

In some embodiments, the comonomer is ethylene.

In some embodiments, the butene-1 copolymer component (A) has a copolymerized comonomer content, alternatively a copolymerized ethylene content, of 0.5-3.0 wt. %, alternatively of 0.7-2.0 wt. %, alternatively of 0.7-1.5 wt. %.

In some embodiments, the butene-1 component (A) is a butene-1 copolymer composition made from or containing:

(A1) a butene-1 homopolymer or a copolymer of butene-1 with a comonomer selected from the group consisting of ethylene, propylene, C5-C10 alpha-olefins and mixtures thereof, having a copolymerized comonomer content (C_{A1}) of up to 3 wt. %, alternatively from 1 wt. % to 3 wt. %; and
(A2) a copolymer of butene-1 with a comonomer selected from the group consisting of ethylene, propylene, C5-C10 alpha-olefins and mixtures thereof, having a copolymerized comonomer content (C_{A2}) of 3-10 wt. %;
wherein the composition having a total copolymerized comonomer content of 0.5-5.0 wt. % referred to the sum of (A1)+(A2). In some embodiments, the composition has a content of fraction soluble in xylene at 0° C. equal to or less than 60 wt. %, determined on the total weight of (A1)+(A2).

In some embodiments, the relative amount of component (A1) and (A2) ranges from 10% to 40% by weight, alternatively from 15% to 35% by weight of (A1) and from 90% to 60% by weight, alternatively from 85% to 65% by weight of (A2), wherein the amounts being referred to the sum of (A1)+(A2).

In some embodiments, the butene-1 copolymer composition is as described in the Patent Cooperation Treaty Publication No. WO2018/007280, which is herein incorporated by reference.

In some embodiments, the butene-1 copolymer component (A) has at least one of the following additional features:

(a) a molecular weight distribution (Mw/Mn) lower than 4, alternatively lower than 3; alternatively lower than 2.5, the lower limit being of 1.5 in the cases; and/or
(b) a weight average molecular weight Mw of from 30,000 to 140,000, alternatively from 30,000 to 80,000; and/or
(c) melting point (TmII) lower than 110° C., alternatively lower than 100° C., alternatively lower than 90° C.; and/or
(d) melting point (TmII) higher than 80° C.; and/or
(e) rotational (Brookfield) viscosity at 180° C. (shear rate 100 s-1) of from 5,000 to 50,000 mPa·sec, alternatively from 8,000 to 20,000 mPa·sec; and/or
(f) X-ray crystallinity in the range 25-60%.

In some embodiments, the butene-1 copolymer (A) has the additional features (a)-(f), inclusive.

In some embodiments, the butene-1 copolymer component (A) has at least one of the following additional features:

(g) glass transition temperature (Tg) in the range from −40° C. to −10° C., alternatively from −30° C. to −10° C.; and/or
(h) storage modulus (E′) at 23° C. equal to or higher than 300 MPa, wherein the glass transition temperature and the storage modulus are measured by Dynamic Mechanical Thermal Analysis (DMTA).

In some embodiments, the butene-1 copolymer component (A) has both additional features (g) and (h).

In some embodiments, the butene-1 copolymer component (A) has at least one of the further following features:

(i) intrinsic viscosity (IV) measured in tetrahydronaphthalene (THN) at 135° C. equal to or lower than 0.8 dl/g, alternatively between 0.2 and 0.6 dl/g; and/or
(ii) a density of higher than 0.885-0.925 g/cm³, alternatively of 0.890-0.920 g/cm³.

In some embodiments, the butene-1 copolymer (A) has both additional features (i) and (ii).

In some embodiments, the butene-1 copolymer (A) has the additional features (a)-(h) and has the additional features (i) and (ii), inclusive.

In some embodiments, the butene-1 copolymer component (A) is obtained by copolymerizing butene-1 and the comonomer in the presence of a catalyst system obtainable by contacting:

a stereorigid metallocene compound;

an alumoxane or a compound capable of forming an alkyl metallocene cation; and, optionally,

an organo aluminum compound.

In some embodiments, the butene-1 copolymer component (A) is prepared with the process and catalyst system as described in Patent Cooperation Treaty Publication Nos. WO2004/099269, WO2006/045687 and WO2018/007280, which are herein incorporated by reference.

In some embodiments, the butene-1 copolymer component (A) is obtained by a polymerization process carried out in one or more reactors connected in series. In some embodiments, the catalyst is added in the first reactor. In some embodiments, the catalyst is added in more than the first reactor. In some embodiments, the polymerization process is as described in Patent Cooperation Treaty Publication No. WO2004/099269. In some embodiments, the polymerization process is carried out in the liquid phase, optionally in the presence of an inert hydrocarbon solvent, or in the gas phase, using fluidized bed or mechanically agitated gas phase reactors. In some embodiments, the polymerization process is carried out by using liquid butene-1 as polymerization medium. In some embodiments, the polymerization temperature ranges from 20° C. to 150° C., alternatively from 50° C. to 90° C., alternatively from 65° C. to 82° C.

In some embodiments, hydrogen is used as a molecular weight regulator as described in Patent Cooperation Treaty Publication No. WO2006/045687. In some embodiments, hydrogen is used to regulate the molecular weight of butene-1 copolymers. In some embodiments, the concentration of hydrogen during the polymerization reaction carried out in the liquid phase is higher than 1800 molar ppm and lower than 6000 molar ppm, alternatively ranges from 2000 molar ppm to 6000 molar ppm.

In some embodiments, butene-1 copolymers having low melting point are obtained by selecting the copolymerized comonomer content, alternatively ethylene content. In some embodiments, the butene-1 copolymer component (A) is obtained with a polymerization process wherein the (total) amount of the comonomer in the liquid phase ranges from 0.1 wt. % to 8 wt. %, alternatively from 0.2 wt. % to 6 wt. %, with respect to the total weight of butene-1 monomer present in the polymerization reactor. In some embodiments, the comonomer is ethylene.

In some embodiments, the butene-1 copolymer (A) is a butene-1 copolymer composition made from or containing the component (A1) and (A2) and the polymerization process includes at least two polymerization stages, carried out in two or more reactors connected in series. In some embodiments, component (A1) is a copolymer, the amount of comonomer in the liquid phase is from 0.1 wt. % to 1.2 wt. % for preparation of component (A1), and the amount of comonomer in the liquid phase is from 1 wt. % to 8 wt. % for preparation of component (A2).

In some embodiments, the inorganic filler (B) is selected from the group consisting of carbonates of alkali metals or alkaline-earth metals, sulfates of alkali metals or alkaline-earth metals, hydroxides of alkali metals or alkaline-earth metals, silicate minerals, synthetic silica, synthetic zeolites, glass, carbon black, inorganic pigments, and mixtures thereof.

In some embodiments, the carbonates, sulfates and/or hydroxides of alkali metals and of alkaline-earth metals are of natural or synthetic origin.

In some embodiments, the inorganic filler (B) is selected from the group consisting of calcium carbonate, magnesium carbonate, calcium sulfate, barium sulfate, magnesium hydroxides and mixtures thereof.

In some embodiments, the inorganic filler (B) is calcium carbonate.

In some embodiments, the inorganic filler (B) has a particle size distribution wherein the d(90) value is equal to or lower than 300 μm.

In some embodiments, the inorganic filler (B) has a particle size distribution wherein the d(10) value is from 0.5 to 10 μm, alternatively from 0.5 to 3 μm, the d(50) value is from 5 to 30 μm, and the d(90) value is from 30 to 300 μm.

In some embodiments, the inorganic filler (B) is calcium carbonate having a particle size distribution as described above.

In some embodiments, the filled polyolefin composition is made from or containing from 10 to 80 wt. %, alternatively from 20 to 75 wt. %, of the inorganic filler (B). In some embodiments, the filled polyolefin composition is made from or containing from 20 to 90 wt. %, alternatively from 25 to 80 wt. %, of the butene-1 copolymer (A). In some embodiments, the filled polyolefin composition is used for forming the secondary backing of carpets.

In some embodiments, the filled polyolefin composition is further made from or containing additives selected from the group consisting of antioxidants, UV stabilizers, aging protection agents, nucleating agents and mixtures thereof. In some embodiments, the total amount of the additives is from 0.01 to 1 wt. %, with respect to the total weight of the filled polyolefin composition.

In some embodiments, the filled polyolefin composition is free of hydrocarbon oils.

In some embodiments, the filled polyolefin composition is prepared by blending of the components in the molten state in a single- or twin screw extruder. In some embodiments, the inorganic component (B) is added to the butene-1 copolymer in powder form, alternatively as a masterbatch.

In some embodiments, the filled polyolefin composition is made from or containing the component (A) and a masterbatch composition made from or containing the inorganic filler (B), wherein the amount of the masterbatch composition in the filled polyolefin composition secures the presence of up to 80 wt. % of the inorganic filler (B) in the filled polyolefin composition.

In some embodiments, the filled polyolefin composition is used in carpet backing.

In some embodiments, the present disclosure provides a method of manufacturing a carpet including a step of applying, to the underside of a primary carpet backing, a layer made from or containing the filled polyolefin composition.

In some embodiments, the method is for the manufacturing of a carpet selected from the group consisting of tufted, needle-punched, woven, knotted and bonded carpets, alternatively for the manufacturing of a tufted carpet.

In some embodiments, the carpets are made from or containing a primary backing, where the face yarn is fixed, a backcoat material adhered to, or coated onto, the primary backing which binds, or anchors, the yarn to the primary backing. In some embodiments, the carpets are made from or containing a secondary backing adhered to the backcoat material of a primary backing, wherein the secondary backing provides dimensional stability to the carpet. In some embodiments, the carpet is made from or containing a plurality of secondary backings further made from or containing adhesive layers to adhere the secondary layers.

In some embodiments, the carpet has a unitary backing. As used herein, the term “unitary backing” refers to a heavy application of a backcoat material applied to the carpet's primary backing, thereby fixing the yarns and providing dimensional stability, without using a secondary backing. In some embodiments, the carpet is tufted carpet.

In some embodiments, the filled polyolefin composition is made from or containing a layer selected from the group consisting of a backcoat material and a secondary backing.

In some embodiments, the step of applying, to the underside of a primary carpet backing, a layer made from or containing the filled polyolefin composition is carried out using a variety of application techniques. In some embodiments, the application techniques are selected from the group consisting of extrusion coating, roller coating and lamination. In some embodiments, the selection of application technique depends on the thickness and viscosity of the layer made from or containing the filled polyolefin composition.

In some embodiments, the present disclosure provides a carpet made from or containing a backing layer made from or containing the filled polyolefin composition.

In some embodiments, the carpet is selected from the group consisting of tufted, needle-punched, woven, knitted and bonded carpets. In some embodiments, the carpet is a tufted carpet.

In some embodiments, the carpet is a tufted carpet tile.

In some embodiments, the carpet is free of bitumen.

In some embodiments, the backing layer has thickness ranging from 0.1 to 5.0 mm, alternatively from 0.1 to 3.0 mm.

In some embodiments, the carpet is made from or containing:

(i) a primary baking;
(ii) a backcoat material adhered on the backside of the primary backing; and
(iii) optionally, one or more secondary backings,
wherein at least one selected among the backcoat material (ii) and the one or more secondary backings (iii) is made from or containing the filled polyolefin composition.

In some embodiments, the primary backing (i) is made from or containing a yarn protruding from the front side of the primary backing and a woven or non-woven fabric made from or containing natural or synthetic fibers selected the group consisting of jute, wool, rayon, polyamides, polyesters, propylene polymers, ethylene polymers and mixtures thereof.

In some embodiments, the primary backing (i) is a film made from or containing a polymer material selected from the group consisting of propylene polymers, ethylene polymers and mixtures thereof.

In some embodiments, the backcoat material (ii) is made from or containing the filled polyolefin composition. In some embodiments, the filled polyolefin composition assists in binding the yarn to the primary backing (i) and provides stiffness to the carpet.

In some embodiments, the layer made from or containing the backcoat material (ii) made from or containing the filled polyolefin composition has a thickness ranging from 0.2 to 5 mm, alternatively from 0.2 to 3 mm.

In some embodiments, the backcoat material (ii) is made from or containing an adhesive material selected the group consisting of latex, natural or synthetic rubber, hot melt adhesives, and the butene-1 copolymer component (A) of the filled polyolefin composition, and mixtures thereof. In some embodiments, the rubber is styrene-butadiene rubber.

In some embodiments, the backcoat material (ii) is made from or containing latex.

In some embodiments, one or more of the secondary backing layers (iii) are made from or containing a variety of materials used in carpet secondary backing. In some embodiments, the materials are selected from the group consisting of woven or non-woven fabrics, films, and foams. In some embodiments, the woven or non-woven fabrics are made from or containing natural fibers or synthetic fibers. In some embodiments, the natural fibers are selected from the group consisting of jute, wool, rayon, and mixtures thereof. In some embodiments, the synthetic fibers are selected from the group consisting of polyamides, polyesters, propylene polymers, ethylene polymers, and mixtures thereof. In some embodiments, the films or foams are made from or containing olefin polymers, polyurethane, latex, and mixtures thereof. In some embodiments, the olefin polymers are selected from the group consisting of propylene polymers and ethylene polymers.

In some embodiments, one or more of the secondary backing layers (iii) are made from or containing the filled polyolefin composition.

In some embodiments, the carpet is made from or containing:

(i) a primary backing;
(ii) a backcoat material adhered on the backside of the primary backing made from or containing an adhesive material selected from the group consisting of latex, the filled polyolefin composition, and the butene-1 copolymer component (A) of the filled polyolefin composition; and
(iii) one or more secondary backing layers,
wherein at least one of the secondary backing layers (iii) is made from or containing the filled polyolefin composition.

In some embodiments, the carpet is made from or containing:

(i) a primary backing; and
(ii) a backcoat material adhered on the backside of the primary backing made from or containing the filled polyolefin composition.

In some embodiments, the carpet has a unitary backing.

In some embodiments, the backcoat material (ii), and optionally the one or more secondary backing layers (iii), are strongly fixed to the primary backing, thereby preventing delamination problems during the service life of the carpet. In some embodiments, the layers delaminate from the primary backing (i), thereby improving the recyclability of the carpet at the end of the carpet's service life.

The following examples are illustrative, and are not intended to limit the scope of the disclosure.

### EXAMPLES

The following analytical methods are used to determine the properties reported in the description and in the examples.

Melt flow rate (MFR) was measured according to ISO 1133-2:2011 (190° C., 2.16 kg, except where different load and temperatures are specified).

Comonomer content (wt. %) measured via IR spectroscopy.

The spectrum of a pressed film of the polymer was recorded in absorbance vs. wavenumbers (cm⁻¹). The following measurements were used to calculate the ethylene content: a) area (At) of the combination absorption bands between 4482 and 3950 cm⁻¹ which is used for spectrometric normalization of film thickness;

b) factor of subtraction (FCR_{C2}) of the digital subtraction between the spectrum of the polymer sample and the absorption band due to the sequences BEE and BEB (B: butene-1 units, E: ethylene units) of the methylenic groups (CH₂ rocking vibration);
c) Area (A_{c2,block}) of the residual band after subtraction of the C2PB spectrum, which comes from the sequences EEE of the methylenic groups (CH₂ rocking vibration).

Apparatus A Fourier Transform Infrared spectrometer (FTIR) was used. A hydraulic press with platens heatable to 200° C. (Carver or equivalent) was used.

Method

Calibration of (BEB+BEE) Sequences

A calibration straight line was obtained by plotting % (BEB+BEE) wt vs. FCR_{C2}/Aₜ. The slope Gr and the intercept Lr were calculated from a linear regression.

Calibration of EEE Sequences

A calibration straight line was obtained by plotting % (EEE) wt vs. A_{C2,block}/Aₜ. The slope GH and the intercept hi were calculated from a linear regression.

Sample Preparation

Using a hydraulic press, a thick sheet was obtained by pressing about 1.5 g of sample between two aluminum foils. If homogeneity was in question, a minimum of two pressing operations were performed. A small portion was cut from the sheet to mold a film. The film thickness ranged between 0.1-0.3 mm. The pressing temperature was 140±10° C. The IR spectrum of the sample film was collected as soon as the sample was molded.

Procedure

The instrument data acquisition parameters were as follows:

Purge time: 30 seconds minimum.
Collect time: 3 minutes minimum.

### Apodization: Happ-Genzel.

Resolution: 2 cm⁻¹.
Collected the IR spectrum of the sample vs. an air background.

Calculation

Calculated the concentration by weight of the BEE+BEB sequences of ethylene units:

$$\% ( BEE + BEB ) wt = Gr \frac{{FCR}_{C 2}}{{A}_{t}} + {I}_{r}$$

Calculated the residual area (AC2,block) after the subtraction, using a baseline between the shoulders of the residual band.
Calculated the concentration by weight of the EEE sequences of ethylene units:

$$\% ( EEE ) w t = {G}_{H} \frac{{A}_{C2 , block}}{{A}_{t}} + {I}_{H}$$

Calculated the total amount of ethylene percent by weight:

% C2 wt=[% (BEE+BEB) wt+% (EEE) wt]

Mw/Mn determination. Measured by way of Gel Permeation Chromatography (GPC) in 1,2,4-trichlorobenzene (TCB). Molecular weight parameters (Mn, Mw, Mz) and molecular weight distributions Mw/Mn for the samples were measured by using a GPC-IR apparatus by PolymerChar, which was equipped with a column set of four PLgel Olexis mixed-bed (Polymer Laboratories) and an IRS infrared detector (PolymerChar). The dimensions of the columns were 300×7.5 mm and the particle size was 13 μm. The mobile phase flow rate was kept at 1.0 mL/min. The measurements were carried out at 150° C. Solution concentrations were 2.0 mg/mL (at 150° C.) and 0.3 g/L of 2,6-di-tert-butyl-p-cresol were added to prevent degradation. For GPC calculation, a calibration curve was obtained using 12 polystyrene (PS) reference samples supplied by PolymerChar (peak molecular weights ranging from 266 to 1220000). A third-order polynomial fit was used to interpolate the experimental data and obtain the relevant calibration curve. Data acquisition and processing were done by using Empower 3 (Waters). The Mark-Houwink relationship was used to determine the molecular weight distribution and the relevant average molecular weights: the K values were KPS=1.21×10⁻⁴ dL/g and KPB=1.78×10⁻⁴ dL/g for PS and polybutene (PB) respectively, while the Mark-Houwink exponents α=0.706 for PS and α=0.725 for PB were used.

For butene/ethylene copolymers, the composition of each sample was assumed constant in the whole range of molecular weight and the K value of the Mark-Houwink relationship was calculated using a linear combination as reported below: K_{EB}=x_{E}K_{PE}+x_{B}K_{PB} where K_{EB} is the constant of the copolymer, K_{PE} (4.06×10⁴, dL/g) and K_{PB} (1.78×10⁴ dL/g) are the constants of polyethylene (PE) and PB, x_{E} and x_{B} are the ethylene and the butene weight relative amount with x_{E}+x_{B}=1. The Mark-Houwink exponents α=0.725 were used for the butene/ethylene copolymers independently on each composition. End processing data treatment was fixed for the samples to include fractions up at 1000 in terms of molecular weight equivalent. Fractions below 1000 were investigated via GC.

The melting point was determined by Differential Scanning calorimetry (D.S.C.) on a Perkin Elmer DSC-7 instrument. The melting temperatures of butene-1 copolymers and the HMA compositions were determined according to the following method:

TmII (melting temperature/s measured in second heating run): a weighed sample (5-10 mg) obtained from the polymerization (or a weighed sample of the HMA composition) was sealed into an aluminium pan and heated at 200° C. with a scanning speed corresponding to 10° C./minute. The sample was kept at 200° C. for 5 minutes, thereby allowing complete melting of the crystallites and cancelling the thermal history of the sample. Successively, after cooling to −20° C. with a scanning speed corresponding to 10° C./minute, the peak temperature was taken as crystallization temperature (Tc). After standing 5 minutes at −20° C., the sample was heated for a second time at 200° C. with a scanning speed corresponding to 10° C./min. In this second heating run, the peak temperature/s measured were marked as (TmII) and the area under the peak (or peaks) as global melting enthalpy (DH TmII).

The melting enthalpy and the melting temperature were measured also after aging (without cancelling the thermal history) as follows by using the Differential Scanning calorimetry (D.S.C.) on a Perkin Elmer DSC-7 instrument. A weighed sample (5-10 mg) obtained from the polymerization (or a weighed sample of the HMA composition) was sealed into an aluminium pan and heated at 200° C. with a scanning speed corresponding to 10° C./minute. The sample was kept at 200° C. for 5 minutes, thereby allowing complete melting of the crystallites. The sample was then stored for 10 days at room temperature. After 10 days, the sample was subjected to DSC, cooled to −20° C., and then heated at 200° C. with a scanning speed corresponding to 10° C./min. In this heating run, the peak temperature (or temperatures when more than one peak was present) were recorded as the melting temperatures (TmI), and the area under the peak (or peaks) was taken as global melting enthalpy after 10 days (DH TmI).

Glass transition temperature (Tg) and Storage Modulus (E′) via Dynamic Mechanical Thermal Analysis (DMTA). Molded specimens (conditioned after molding for 40 h at 23°±2° C. and 50% relative humidity) of 80 mm by 10 mm by 1 mm were fixed to the DMTA machine for tensile stress. The frequency of the tension and relies of the sample was fixed at 1 Hz. The DMTA translated the elastic response of the specimen starting from −100° C. to 130° C., using a heating rate of 2° C./min. The elastic response was plotted versus temperature. The elastic modulus for a viscoelastic material was defined as E=E′+iE″. In some instances, the DMTA split the two components E′ and E″ by resonance and plotted E′ vs temperature and E/E″=tan (δ) vs temperature. The glass transition temperature Tg was assumed to be the temperature at the maximum of the curve E/E″=tan (δ) vs temperature.

Rotational (Brookfield) viscosity was measured at 180° C. and a deformation rate of and 100 s-1, using a Rheolab QC instrument, which was a rotational rheometer, including a high-precision encoder and a dynamic EC motor. In some instances, the controlled shear rate (CR) or the controlled shear stress (CS) test settings were selected. During the test, the sample was subjected at a deformation rate sweep from 1 s-1 to 1000 s-1. The torque was measured for each deformation rate and the corresponding viscosity was calculated by the instrument software.

Crystallinity was measured by X-Ray diffraction according to the following method: The instrument used to measure crystallinity was an X-ray Diffraction Powder Diffractometer (XDPD) that used the Cu-Kα1 radiation with fixed slits and able to collect spectra between diffraction angle 2Θ=5° and 2Θ=35° with step of 0.1° every 6 seconds.

The samples were diskettes of about 1.5-2.5 mm of thickness and 2.5-4.0 cm of diameter made by compression molding. The diskettes were aged at 23° C. for 96 hours.
After this preparation, the specimen was inserted in the XDPD sample holder. The XRPD instrument was set to collect the XRPD spectrum of the sample from diffraction angle 2Θ=5° to 2Θ=35° with step of 0.1° by using counting time of 6 seconds. At the end, the final spectrum was collected.
Ta was defined as the total area between the spectrum profile and the baseline expressed in counts/sec·2Θ; Aa was defined as the total amorphous area expressed in counts/sec·2Θ. Ca was defined as the total crystalline area expressed in counts/sec·2Θ.
The spectrum or diffraction pattern was analyzed in the following steps:
1) defined a linear baseline for the whole spectrum and calculated the total area (Ta) between the spectrum profile and the baseline;
2) defined an amorphous profile, along the whole spectrum that separated the amorphous regions from the crystalline regions according to the two phase model;
3) calculated the amorphous area (Aa) as the area between the amorphous profile and the baseline; 4) calculated the crystalline area (Ca) as the area between the spectrum profile and the amorphous profile as Ca=Ta−Aa; and
5) calculated the degree of crystallinity of the sample using the following formula:

%Cr=100×Ca/Ta

Intrinsic viscosity: determined in tetrahydronaphthalene at 135° C. according to norm ASTM D 2857-16.

Density: Determined according to norm ISO 1183-1:2012, method A, Part 1: immersion method. Test specimens were obtained by compression molded plaques. Density was measured after 10 days conditioning.

Fractions soluble and insoluble in xylene at 0° C.: 2.5 g of polymer composition and 250 cm³ of o-xylene were introduced into a glass flask equipped with a refrigerator and a magnetic stirrer. The temperature was raised in 30 minutes up to the boiling point of the solvent. The resulting clear solution was then kept under reflux and stirring for further 30 minutes. The closed flask was then cooled to 100° C. in air for 10 to 15 minutes under stirring and then kept for 30 minutes in a thermostatic water bath at 0° C. for 60 minutes. The resulting solid was filtered on quick filtering paper at 0° C. 100 cm³ of the filtered liquid was poured in a pre-weighed aluminum container which was heated on a heating plate under nitrogen flow, thereby removing the solvent by evaporation. The fraction (percent by weight) of polymer soluble in xylene (XS) was calculated from the average weight of the residues. The polymer fraction insoluble in o-xylene at 0° C. (XI) was calculated as: XI (%)=100−XS (%).

Flexural modulus was measured according to ISO 178:2010. Specimens for flexural test were cut from compression molded plaques pressed at 200° C. and aged via autoclave at RT for 10 min at 2 kbar. Specimens thickness was 4 mm.

Particle size distribution was measured by laser diffraction according to ISO 13320:2009.

Preparation of catalyst components: Dimethylsilyl{(2,4,7-trimethyl-1-indenyl)-7-(2,5-dimethyl-cyclopenta[1,2-b:4,3-b′]-dithiophene)} zirconium dichloride (metallocene A-1) was prepared according to Example 32 of Patent Cooperation Treaty Publication No. WO01/47939.

Preparation of the catalytic solution: Under nitrogen atmosphere, 6400 g of a 33 g/L solution of TIBA in isododecane and 567 g of 30% wt/wt solution of MAO in toluene were loaded in a 20 L jacketed glass reactor, stirred by an anchor stirrer, and allowed to react at room temperature for about 1 hour under stirring.

After this time, 1.27 g of metallocene A-1 was added and dissolved under stirring for about 30 minutes.

The final solution was discharged from the reactor into a cylinder through a filter to remove solid residues.

The resulting composition of the solution was:

| Al | Zr | Al/Zr | metallocene conc. |
|---|---|---|---|
| (wt. %) | (wt. %) | (mol ratio) | (mg/l) |
| 1.72 | 0.0029 | 2001 | 137 |

Polymerization of the butene-1 copolymer. The polymerization was carried out in two stirred reactors operated in series, wherein liquid butene-1 constituted the liquid medium. The catalyst system was fed in both reactors. The polymerization conditions are reported in Table 1. The butene-1 copolymer was recovered as melt from the solution and cut in pellets. The copolymer was further characterized and the data are reported in Table 2.

TABLE 1
First reactor

| | | |
|---|---|---|
| Temperature | ° C. | 75 |
| H2 in liquid phase | molar ppm | 3248 |
| C2 in liquid phase | wt. % | 0.3 |
| Mileage | Kg/gMe | 1485 |
| Split | wt. % | 60 |
| C2 content (A1) | wt. % | 1 |
| C2 content (A1) | mole % | 1.98 |

Second reactor

| | | |
|---|---|---|
| Temperature | ° C. | 75 |
| H2 in liquid phase | molar ppm | 3248 |
| C2 in liquid phase | wt. % | 0.4 |
| Split | wt. % | 40 |
| C2 content (A1) | wt. % | 1 |
| C2 content (A1) | mole % | 1.98 |
| Total mileage | Kg/gMe | 1539 |
| Total C2 content | wt. % | 1.0 |
| Total C2 content | mole % | 1.98 |

Note:
kg/gMe = kilograms of polymer per gram of metallocene A-1; Split = amount of polymer produced in the concerned reactor.

TABLE 2

| | | PB-1 |
|---|---|---|
| MFR (190° C./2.16 Kg) | g/10 min. | 1200 |
| Intrinsic viscosity (IV) | dl/g | 0.4 |
| Mw/Mn | | 2.1 |
| Mw | | 50,000 |
| TmII | ° C. | 81.9 |
| TmI | ° C. | 103 |
| Tg | ° C. | −10 |
| Viscosity (180° C.) | mPa · s | 10,000 |
| Crystallinity | % | 58 |
| Density | g/cm³ | 0.9090 |
| Flexural Modulus | MPa | 350 |
| Storage modulus at 23° C. | MPa | 316 |

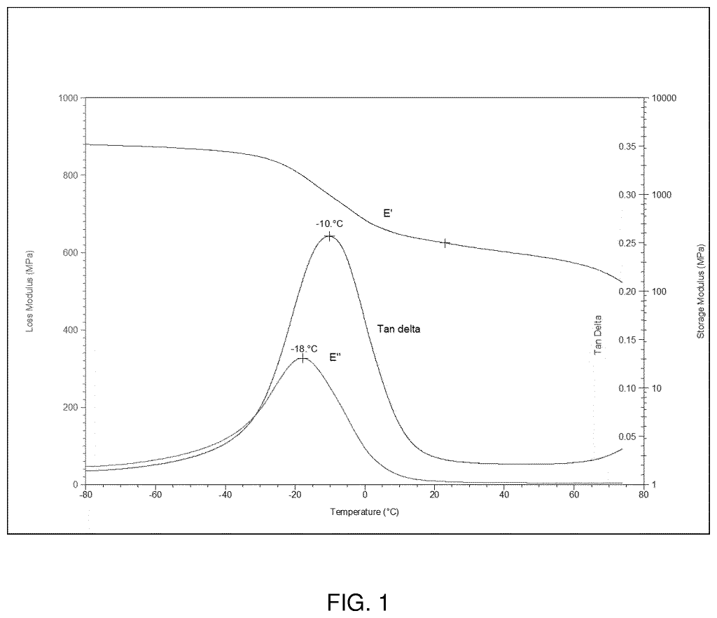

FIG. 1 is a graph showing the viscoelastic properties (E′, E″ and Tan 6) of the butene-1 copolymer plotted as function of temperature, measured by DMTA.

### Example 1-3

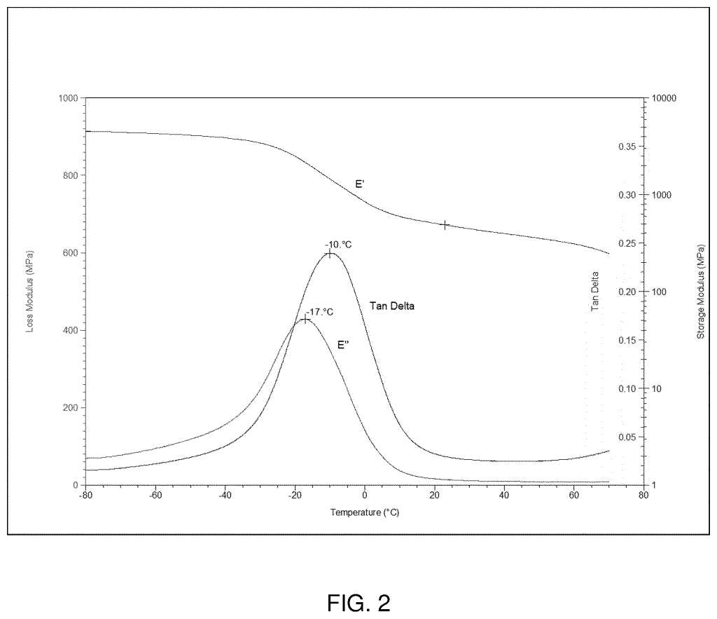

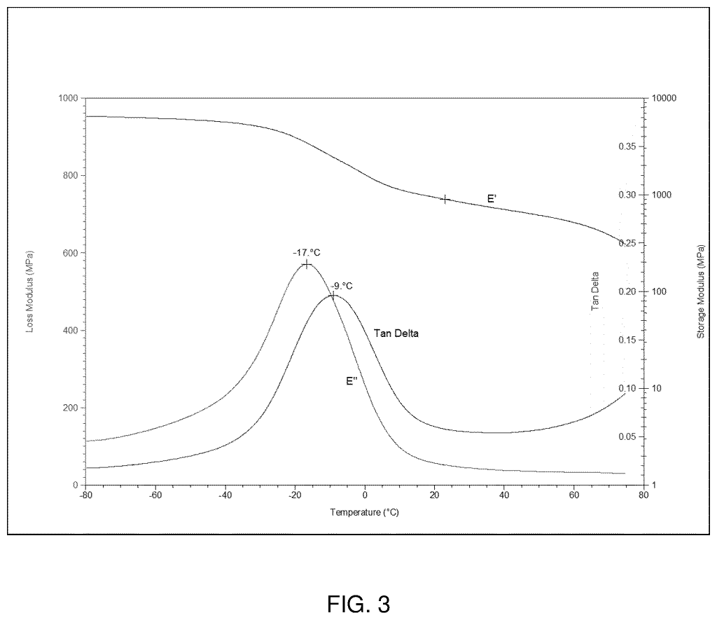

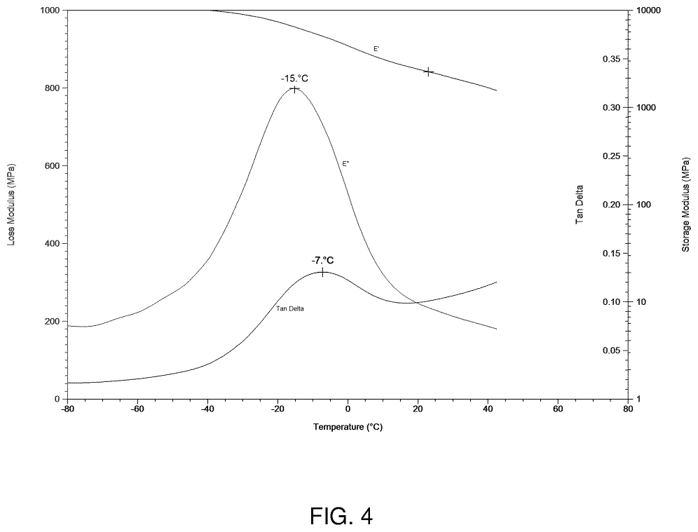

Filled polyolefin compositions were prepared by blending, in the molten state, the butene-1 copolymer and different amounts of calcium carbonate having particle size distribution wherein d(10) was 1 μm, d(50) was 9 μm and d(90) was 40 μm. The amount of component (A) and (B), the MFR values and storage modulus of the compositions of the examples are indicated in Table 3. FIGS. 2-4 are graphs showing the viscoelastic properties of the polyolefin composition of Examples 1-3, respectively, plotted as a function of temperature, measured according to the DMTA Method.

TABLE 3

| | | Example | Example | Example |
|---|---|---|---|---|
| | | 1 | 2 | 3 |
| PB-1 | wt. % | 75 | 50 | 25 |
| CaCO₃ | wt. % | 25 | 50 | 75 |
| MFR (190° C./2.16 Kg) | g/10 min. | 840 | 610 | 300 |
| Storage modulus 23° C. | MPa | 489 | 896 | 2332 |

The filled polyolefin compositions were used to manufacture the secondary backing of a turfed tile carpet by extrusion coating the compositions of Examples 1-3 to the underside of a carpet made from or containing polyamine yarn fixed into a polypropylene primary backing and latex as backcoat material. A minimum force was used to delaminate the primary and secondary backings.

What is claimed is:

1. A filled polyolefin composition comprising:
(A) a copolymer of butene-1 with a comonomer selected from the group consisting of ethylene, propylene, C5-C10 alpha-olefins and mixtures thereof, having copolymerized comonomer content of 0.5-5.0 wt. % and Melt Flow Rate (MFR) values measured according to ISO 1133 (190° C., 2.16 kg) higher than or equal to 200 g/10 min and
(B) up to 80 wt. % of an inorganic filler,
wherein the amounts of (A) and (B) are referred to the total weight of (A)+(B).

2. The filled polyolefin composition according to claim 1, wherein the butene-1 copolymer component (A) has a Melt Flow Rate MFR measured according to ISO 1133 (190° C., 2.16 kg) of from 200 to 3,000 g/10 min.

3. The filled polyolefin composition according to claim 1, wherein the comonomer is selected from the group consisting of ethylene, propylene, hexene-1, octene-1 and mixture thereof.

4. The filled polyolefin composition according to claim 1, wherein the butene-1 copolymer component (A) has a copolymerized comonomer content of 0.5-3.0 wt.

5. The filled polyolefin composition according to claim 1, wherein the butene-1 copolymer component (A) has at least one of the following additional features:
(a) a molecular weight distribution (Mw/Mn) lower than 4, the lower limit being of 1.5; and/or
(b) a weight average molecular weight Mw of from 30,000 to 140,000; and/or
(c) melting point (TmII) lower than 110° C. and/or
(d) melting point (TmII) higher than 80° C.; and/or
(e) rotational (Brookfield) viscosity at 180° C. (shear rate 100 s-1) of from 5,000 to 50,000 mPa·sec; and/or
(f) X-ray crystallinity in the range 25-60%.

6. The filled polyolefin composition according to claim 1, wherein the butene-1 copolymer component (A) has at least one of the following additional features:
(g) glass transition temperature (Tg) in the range from −40° C. to −10° C.; and/or
(h) storage modulus at 23° C. equal to or higher than 300 MPa,
wherein the glass transition temperature and the storage modulus are measured by Dynamic Mechanical Thermal Analysis (DMTA).

7. The filled polyolefin composition according to claim 1, wherein the inorganic filler (B) is selected from the group consisting of carbonates of alkali metals or alkaline-earth metals, sulfates of alkali metals or alkaline-earth metals, hydroxides of alkali metals or alkaline-earth metals, silicate minerals, synthetic silica, synthetic zeolites, glass, carbon black, inorganic pigments and mixtures thereof.

8. The filled polyolefin composition according to claim 1, wherein the inorganic filler (B) is selected from the group consisting of calcium carbonate, magnesium carbonate, calcium sulfate, barium sulfate, magnesium hydroxides and mixtures thereof.

9. The filled polyolefin composition according to claim 1, wherein the inorganic filler (B) has a particle size distribution wherein the d(90) value is equal to or lower than 300 μm.

10. The filled polyolefin composition according to claim 1, comprising 10-80 wt. % of the inorganic filler (B).

11. A method of manufacturing a carpet comprising a step of applying, to the underside of a primary carpet backing, a layer comprising the filled polyolefin composition according to claim 1.

12. A carpet comprising a backing layer comprising the filled polyolefin composition according to claim 1.

13. The carpet according to claim 12, wherein the backing layer has thickness ranging from 0.1 to 5.0 mm.

14. The carpet according to claim 12 comprising:
(i) a primary baking;
(ii) a backcoat material adhered on the backside of the primary backing; and
(iii) optionally, one or more secondary backing layers,
wherein at least one selected among the backcoat material (ii) and the one or more secondary backing layers (iii) comprises the filled polyolefin composition according to claim 1.

15. The carpet according to claim 12 comprising:
(i) a primary backing;
(ii) a backcoat material adhered on the backside of the primary backing, comprising the filled polyolefin composition according to claim 1.
